(19) United States
(12) Patent Application Publication
(10) Pub. No.: US 2004/0085719 A1
(43) Pub. Date: May 6, 2004

(54) Computer casing

(76) Inventor: Yuhwen Huang, Tainan City (TW)

Correspondence Address: TROP PRUNER & HU, PC, 8554 KATY FREEWAY, SUITE 100, HOUSTON, TX, 77024, US

(21) Appl. No.: 10/284,947

(22) Filed: Oct. 31, 2002

(51) Int. Cl. G06F 1/16

(52) U.S. Cl. 361/683

(57) ABSTRACT

A computer casing includes a side plate with an end portion which is hinged to a lateral wall of one of a front panel and a rear plate such that an opposite end portion of the side plate is rotatable between open and close positions to open and cover an access opening between the front panel and the rear plate. At least one fastening mechanism is disposed to releasably fasten the side plate to a corresponding one of the front panel and rear plate.

### BACKGROUND OF THE INVENTION

1. Field of the Invention

This invention relates to a computer casing, more particularly to a computer casing with a side plate which is hinged relative to a lateral wall of one of a front panel and a rear plate so as to be rotatable relative thereto between open and close positions.

2. Description of the Related Art

Referring to FIG. 1, a conventional computer casing 1 is shown to include a rectangular main body 11, two side plates 12 which are disposed respectively at two lateral sides of the main body 11, and a plurality of screw fasteners 13 which secure the side plates 12 to the lateral sides. In particular, the main body 11 has two fixed side frames 14 to confine an access opening. Each side frame 14 includes a front portion 141 formed with retaining members 145, and upper and lower portions 142,143 formed with engaging slots 144. Each side plate 12 has hooks 121 and protrusions 122 corresponding to and engaging the engaging slots 144 and the retaining members 145 of a respective one of the side frames 14, respectively, such that the side plate 12 can be detachably coupled to the respective one of the side frames 14 for covering the access opening. The side plates 12 are secured to the side frames 14, respectively, by means of the screw fasteners 13. However, during assembly, precise alignment of the hooks 121 with the engaging slots 144, and pressing the side plate 12 forwardly are required, which is inconvenient.

### SUMMARY OF THE INVENTION

The object of the present invention is to provide a computer casing which is conveniently assembled and disassembled.

According to this invention, the computer casing includes a front panel and a rear plate which are spaced apart from each other in a longitudinal direction and which respectively have front and rear major walls that stand in an upright direction and that confront each other to confine an accommodation chamber adapted for receiving a computer motherboard therein. The front panel and the rear plate respectively have front and rear lateral walls which face toward a transverse direction that is transverse to the longitudinal and upright directions and which are spaced apart from each other in the longitudinal direction to confine an access opening that communicates with the accommodation chamber. A side plate is configured to cover the access opening, and has front and rear end portions which are disposed proximate to the front and rear lateral walls, respectively. A hinge member is disposed to hinge one of the front and rear end portions relative to a respective one of the front and rear lateral walls about an axis in the upright direction, such that the other one of the front and rear end portions is rotatable relative to the other one of the front and rear lateral walls about the axis between an open position, where the other one of the front and rear end portions is remote from the other one of the front and rear lateral walls, and a close position, where the other one of the front and rear end portions is proximate to the other one of the front and rear lateral walls so as to cover the access opening. At least one fastening mechanism is disposed to releasably fasten the other one of the front and rear end portions to the other one of the front and rear lateral walls in the close position.

### BRIEF DESCRIPTION OF THE DRAWINGS

Other features and advantages of the present invention will become apparent in the following detailed description of the preferred embodiments of the invention, with reference to the accompanying drawings, in which:

FIG. 1 is an exploded perspective view of a conventional computer casing;

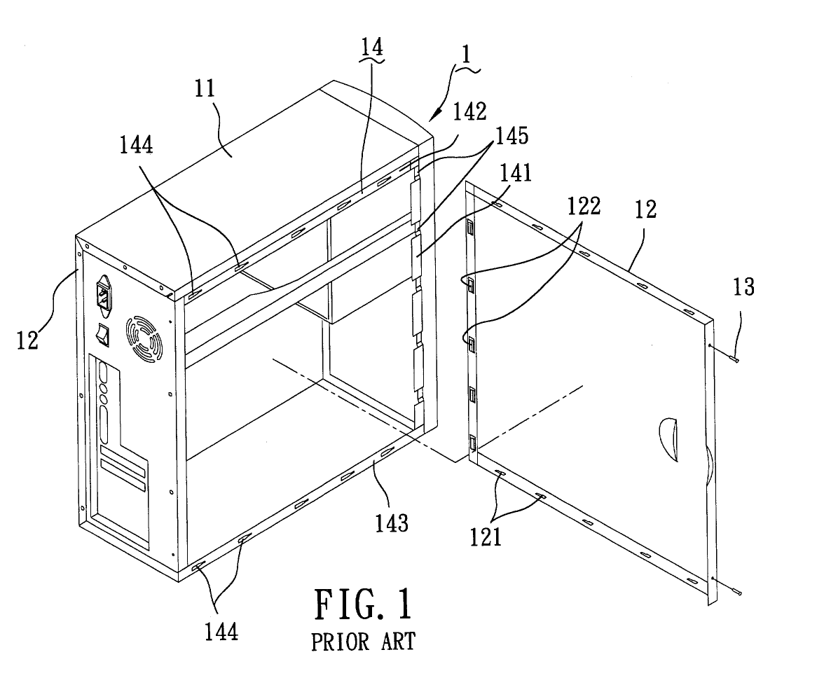

FIG. 2 is a perspective view of a first preferred embodiment of a computer casing according to this invention in an open state;

FIG. 3 is a sectional view of the computer casing shown in FIG. 2, taken along lines III-III thereof, showing the computer casing in an opened state;

FIG. 4 is a sectional view showing the preferred embodiment in a closed state;

FIG. 5 is a sectional view showing the preferred embodiment in a locked state;

FIG. 6 is a perspective view of an actuator of the preferred embodiment;

FIG. 7 is a perspective view of a second preferred embodiment of a computer casing according to this invention in an open state; and

FIG. 8 is a sectional view of the preferred embodiment in a locked state.

### DETAILED DESCRIPTION OF THE PREFERRED EMBODIMENTS

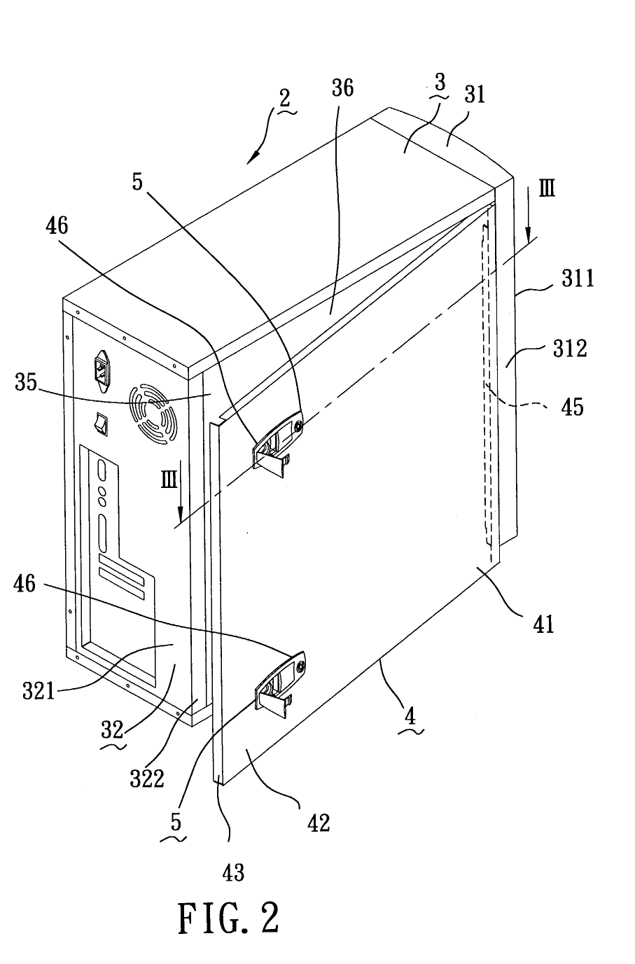

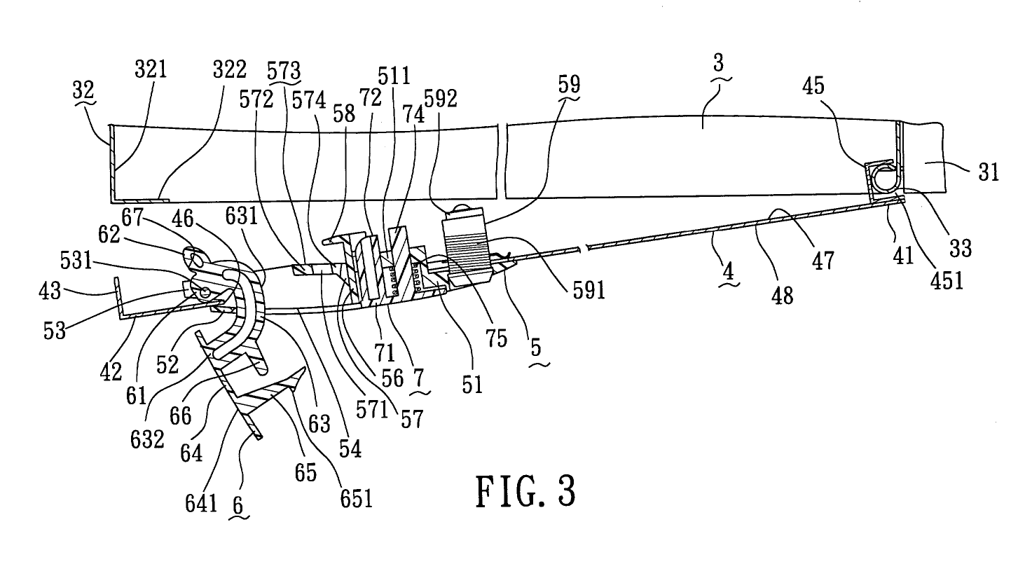

Referring to FIGS. 2 and 3, the first preferred embodiment of the computer casing 2 according to the present invention is shown to comprise a main frame 3, a side plate 4, and two fastening mechanisms 5.

The main frame 3 includes a front panel 31 and a rear plate 32 which are spaced apart from each other in a longitudinal direction and which respectively have front and rear major walls 311,321 that stand in an upright direction and that confront each other to confine an accommodation chamber 35 for receiving a computer motherboard (not shown) therein. In addition, the front panel 31 and the rear plate 32 respectively have front and rear lateral walls 312,322 which face toward a transverse direction that is transverse to the longitudinal and upright directions and which are spaced apart from each other in the longitudinal direction to confine an access opening 36 that communicates with the accommodation chamber 35.

The side plate 4 is configured to cover the access opening 36, and has front and rear end portions 41,42 which are disposed proximate to the front and rear lateral walls 312,322, respectively. A bending edge wall 43 extends transversely from the rear end portion 42, and is configured to abut against the rear major wall 321 when the side plate 4 covers the access opening 36. Moreover, the side plate 4 has inner and outer major surfaces 47,48 opposite to each other in the transverse direction. Two mounting holes 46 are formed in the outer major surface 48 through the inner major surface 47 proximate to the rear end portion 42.

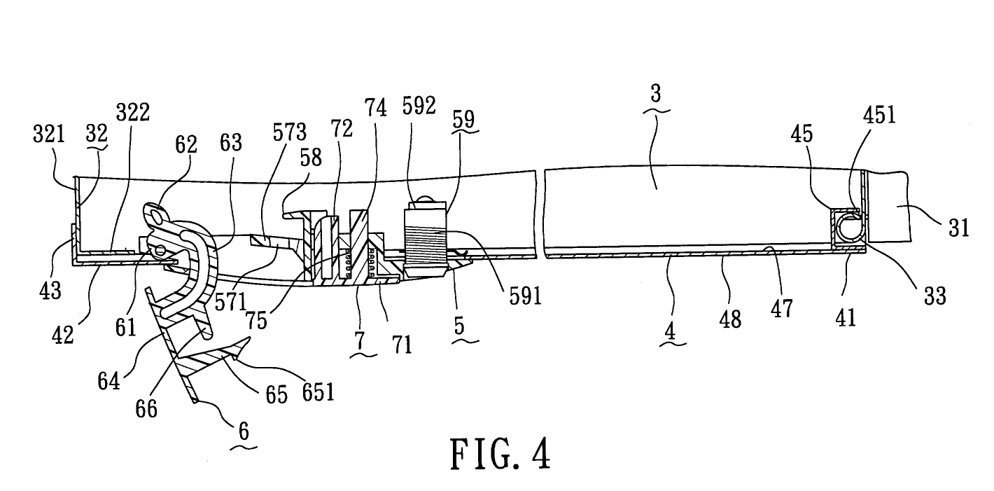

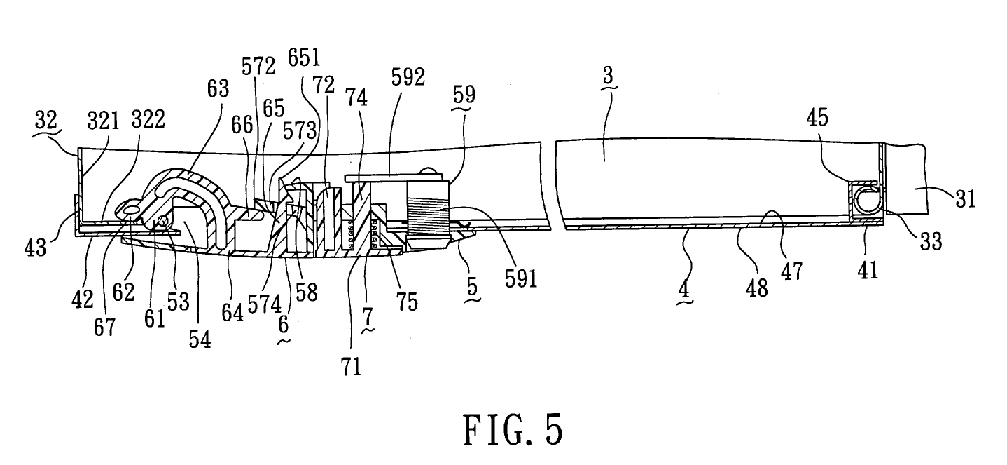

A hinge member includes a pivot pin 33 which is formed on the front major wall 311 of the front panel 31 adjacent to the front lateral wall 312 and which is elongated along a first axis in the upright direction, and a knuckle 45 which is disposed on the inner major surface 47 of the side plate 4 at the front end portion 41 to receive the pivot pin 33. As such, the rear end portion 42 is swingable relative to the pivot pin 33 between an open position, where the rear end portion 42 is remote from the rear lateral wall 322, as shown in FIG. 3, and a close position, where the rear end portion 42 is proximate to the rear lateral wall 322 so as to cover the access opening 36, as shown in FIGS. 4 and 5. Moreover, the knuckle 45 extends in the upright direction, and has an insertion slot 451 which extends in the upright direction and which is configured to permit insertion of the pivot pin 33 thereinto when the insertion slot 451 faces forwardly and to permit disengagement of the knuckle 45 from the pivot pin 33 when the rear end portion 42 is swung to the open position.

With reference to FIG. 3, each fastening mechanism 5 is received in a respective one of the mounting holes 46, and includes a mount base 51 and a pivot unit 6.

The mount base 51 includes a face plate 52 which is secured in the respective mounting hole 46 and which has a through opening 54 to communicate with the respective mounting hole 46 so as to configure the side plate 4 with mount and anchored regions at two opposite sides of the through opening 54 in the longitudinal direction. The mount and anchored regions are proximate to and distal from the rear end portion 42 of the side plate 4, respectively.

At the anchored region of the side plate 4, an anchored seat 57 is disposed on an inner surface of the face plate 52, and has an anchored end 573 which is spaced apart from the inner surface of the face plate 52 in the transverse direction. The anchored end 573 includes inner proximate and distal edges 572,574 relative to the rear end portion 42 and spaced apart from each other in the longitudinal direction to confine an insert slot 571. The anchored end 573 is made from a flexible material so as to acquire a biasing force when the anchored end 573 is bent inwardly. In addition, a partition wall 56 is disposed on the inner surface of the face plate 52 adjacent to the anchored seat 57, and has a pressing portion 58 extending rearwardly therefrom.

At the mount region of the side plate 4, a mount seat 53 is disposed on the inner surface of the face plate 52, and has a pivot pin 531 which extends in the upright direction along the second axis that is parallel to the first axis.

The pivot unit 6 includes a pivoted body 61 which is pivotally mounted on the pivot pin 531 about the second axis, a depressing finger 62 which extends from the pivoted body 61 in a radial direction relative to the second axis. As such, the depressing finger 62 is movable between a latched position, as shown in FIG. 5, where an abutting surface 67 of the depressing finger 62 abuts against the rear lateral wall 322 from inside when the rear end portion 42 is in the close position, and an unlatched position, as shown in FIGS. 3 and 4, where the abutting surface 67 of the depressing finger 62 is remote from the rear lateral wall 322 through a clockwise movement of the depressing finger 62 about the second axis.

In addition, a tongue member 63 is disposed forwardly of the depressing finger 62 in a clockwise direction. The tongue member 63 extends from the pivoted body 61 and angles away from the depressing finger 62 about the second axis to form a middle segment 631 which extends outwardly of the through opening 54 and which terminates at a leading head 632. A retaining member 64 extends from the leading head 632 radially and outwardly to form an interconnecting portion 641, and extends angularly and in a counterclockwise direction to form a stem portion 65 and to terminate at an anchoring end 651 of a tapered shape. In addition, a push member 66 extends from the middle segment radially and outwardly relative to the second axis. As such, referring to FIG. 5, when the anchoring end 651 is brought to turn counterclockwise through the insert slot 571 so as to abut against and to be retained at the inner distal edge 574, the depressing finger 62 is brought from the unlatched position to the latched position. In this state, the push member 66 is moved to thrust the anchored end 573 away from the inner major surface 47 of the side plate 4 so as to provide the inner proximate edge 572 with the biasing force.

Once the anchoring end 651 is shifted towards the inner proximate edge 572 by an actuator 7 (to be described in greater detail in the succeeding paragraphs) so as to extend outwardly of the insert slot 571, the biasing force of the inner proximate edge 572 can bias the anchoring end 651 to turn clockwise so as to facilitate movement of the anchoring end 651 out of the insert slot 571.

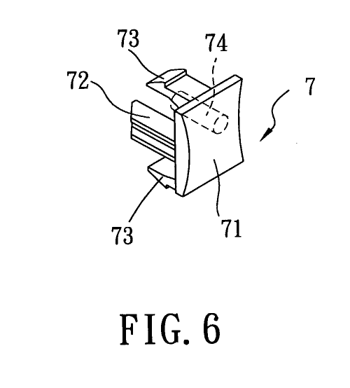

With reference to FIGS. 3 and 6, the actuator 7 is disposed in the respective mounting hole 46 at a side of the partition wall 56 opposite to the anchored seat 57, and is movable relative to the anchored region of the side plate 4 in the transverse direction. The actuator 7 includes an operated wall 71 which extends in the longitudinal direction to be operated outwardly, two anchoring portions 73, a shift shank 72, and a guiding rod 74 which respectively extend from the operated wall 71 in the transverse direction. The anchoring portions 73 are disposed to anchor on an inner wall 511 of the mount base 51 so as to prevent removal of the actuator 7 from the side plate 4. A biasing member 75 is disposed between the inner wall 511 of the mount base 51 and the operated wall 71 so as to bias the actuator 7 outwardly to move away from the accommodation chamber 35.

Moreover, a key-operated lock 59 is disposed at the anchored region of the side plate 4 to extend through the respective mounting hole 46, and includes a spindle 591 which extends inwardly of the inner major surface 47 of the side plate 4 and which is operable externally, and a block arm 592 which is coupled to the spindle 591 and which extends inwardly. The spindle 591 is key-operable to place the block arm 592 in a blocked position to prevent the actuator 7 from moving towards the accommodation chamber 35.

Thus, when it is desired to detach the side plate 4 from the main frame 3, the block arm 592 is moved from the blocked position. The operated wall 71 is pressed manually and inwardly towards the accommodation chamber 35 such that the shift shank 72 can press the pressing portion 58 so as to shift the anchoring end 651 towards the inner proximate edge 572. In this state, the anchoring end 651 is moved out of the insert slot 571 by means of the biasing force of the anchored end 573, and the depressing finger 62 is rotated-to the unlatched position, as shown in FIG. 4. Then, the rear end portion 42 of the side plate 4 is swung to the open position such that the knuckle 45 is disengaged from the pivot pin 33.

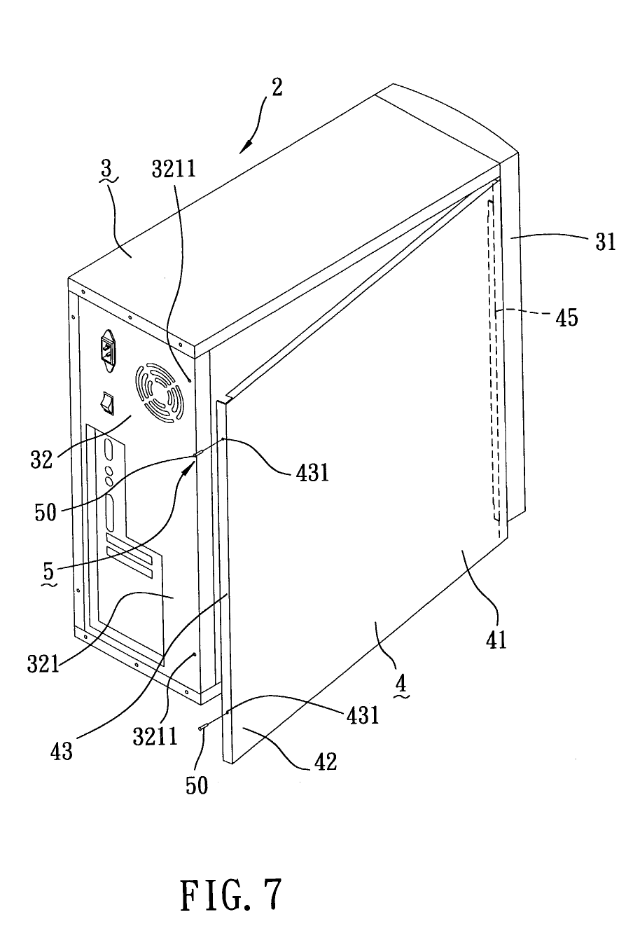

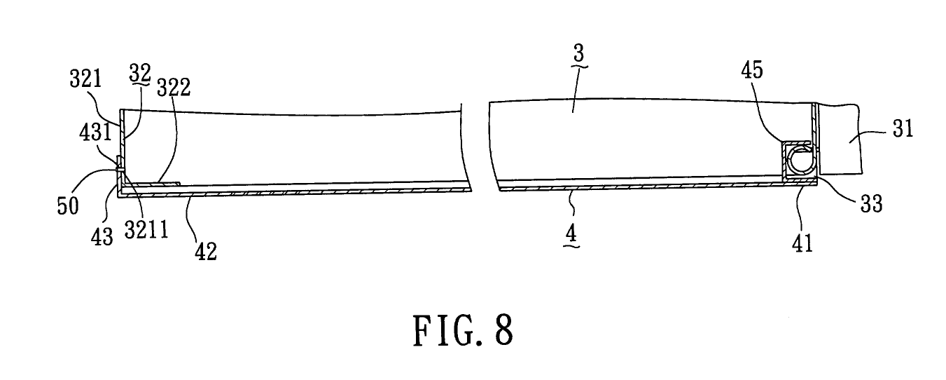

Referring to FIGS. 7 and 8, the second preferred embodiment of the computer casing 2 according to this invention is shown to be similar to the first preferred embodiment in construction, except that each of the fastening mechanisms 5 includes through holes 431,3211 which are formed respectively in the bending edge wall 43 of the side plate 4 and the rear major wall 321 of the rear plate 32 and which are aligned with each other in the longitudinal direction when the rear end portion 42 of the side plate 4 is in the close position, and a screw fastener 50 which passes through the through holes 431,3211.

As illustrated, by means of the hinge member, the rear end portion 42 of the side plate 4 is swingable between the open and close positions relative to the main frame 3. The fastening mechanisms 5 are disposed to fasten the rear end portion 42 to the main frame 3 when the side plate 4 is in the close position. Thus, the assembly and disassembly of the computer casing 2 are convenient.

While the present invention has been described in connection with what is considered the most practical and preferred embodiments, it is understood that this invention is not limited to the disclosed embodiments but is intended to cover various arrangements included within the spirit and scope of the broadest interpretations and equivalent arrangements.

I claim:

1. A computer casing comprising:
a front panel and a rear plate which are spaced apart from each other in a longitudinal direction, and which respectively have front and rear major walls that stand in an upright direction and that confront each other to confine an accommodation chamber adapted for receiving a computer motherboard therein, said front panel and said rear plate respectively having front and rear lateral walls which face toward a transverse direction that is transverse to the longitudinal and upright directions and which are spaced apart from each other in the longitudinal direction to confine an access opening that communicates with said accommodation chamber;
a side plate configured to cover-said access opening, and having front and rear end portions which are disposed proximate to said front and rear lateral walls, respectively;
a hinge member disposed to hinge one of said front and rear end portions relative to a respective one of said front and rear lateral walls about a first axis in the upright direction, such that the other one of said front and rear end portions is rotatable relative to the other one of said front and rear lateral walls about the first axis between an open position, where said other one of said front and rear end portions is remote from said other one of said front and rear lateral walls, and a close position, where said other one of said front and rear end portions is proximate to said other one of said front and rear lateral walls so as to cover said access opening;
at least one fastening mechanism disposed to releasably fasten said other one of said front and rear end portions to said other one of said front and rear lateral walls in the close position.

2. The computer casing of claim 1, wherein said side plate has inner and outer major surfaces opposite to each other in the transverse direction, said hinge member including a pivot pin which is disposed on said front major wall adjacent to said front lateral wall and which is elongated along the first axis, and a knuckle which is disposed on said inner major surface at said front end portion to receive said pivot pin such that said rear end portion is swingable between the open and close positions relative to said pivot pin.

3. The computer casing of claim 2, wherein said knuckle extends in the upright direction, and has an insertion slot extending in the upright direction and configured to permit insertion of said pivot pin thereinto when said insertion slot faces forwardly and to permit disengagement of said knuckle from said pivot pin when said rear end portion is swung to the open position.

4. The computer casing of claim 2, wherein said side plate includes mount and anchored regions which are proximate to and distal from said rear end portion, respectively, and which are spaced apart from each other in the longitudinal direction to confine a through opening therebetween which extends from said outer major surface to said inner major surface, and wherein said fastening mechanism includes
an anchored seat disposed on said inner major surface at said anchored region,
a mount seat disposed on said inner major surface at said mount region,
a pivoted body pivotally mounted on said mount seat about a second axis parallel to the first axis;
a depressing finger extending from said pivoted body in a radial direction relative to the second axis, and movable between a latched position, where said depressing finger abuts against said rear lateral wall from inside, and an unlatched position, where said depressing finger is remote from said rear lateral wall through a clockwise movement of said depressing finger about the second axis,
a tongue member disposed forwardly of said depressing finger in clockwise direction, said tongue member extending from said pivoted body and angling away from said depressing finger about the second axis to form a middle segment which extends outwardly of said through opening and which terminates at a leading head, and
a retaining member which extends from said leading head radially and outwardly to form an interconnecting portion, and which extends angularly and in a counterclockwise direction to form a stem portion and which terminates at an anchoring end such that when said anchoring end is brought to turn counterclockwise so as to engage retainingly said anchored seat, said depressing finger is brought to move from the unlatched position to the latched position.

5. The computer casing of claim 4, wherein said anchored seat has an anchored end which is disposed to be spaced apart from said inner major surface in the transverse direction, and which includes inner proximate and distal edges relative to said pivoted body and spaced apart from each other in the longitudinal direction to confine an insert slot, and wherein said anchoring end is tapered such that said anchoring end is brought to extend through said insert slot so as to either abut against and be retained at said inner distal edge, or be removed from said inner distal edge and out of said insert slot once said anchoring end is shifted towards said inner proximate edge.

6. The computer casing of claim 5, wherein said anchored end is made from a bendable material so as to acquire a biasing force when said anchored end is bent away from said inner major surface, said computer casing further including a push member disposed to extend from said middle segment radially and outwardly relative to the second axis such that when said anchoring end is retained at said inner distal edge, said push member is moved to thrust said anchored end away from said inner major surface so as to provide said inner proximate edge with the biasing force which biases said anchoring end to turn clockwise so as to move out of said insert slot once said anchoring end is shifted towards said inner proximate edge.

7. The computer casing of claim 6, further comprising an actuator disposed to extend through and to be movable relative to said anchored region in the transverse direction such that when said actuator is actuated externally to move towards said accommodation chamber, said anchoring end is shifted towards said inner proximate edge.

8. The computer casing of claim 7, further comprising a biasing member disposed to bias said actuator to move away from said accommodation chamber.

9. The computer casing of claim 8, further comprising a block arm disposed inwardly of said inner major surface at said anchored region to prevent said actuator from moving towards said accommodation chamber when said block arm is moved to a blocked position.

10. The computer casing of claim 9, further comprising a key-operated lock disposed to extend through said anchored region, said key-operated lock being externally operable and having a spindle extending inwardly of said inner major surface and coupled to said block arm so as to be key-operable to place said block arm in the blocked position.

11. The computer casing of claim 2, wherein said side plate further has a bending edge wall which extends from said rear end portion in the transverse direction so as to abut against said rear major wall when said rear end portion is in the close position, and wherein said fastening mechanism includes through holes formed respectively in said bending edge wall and said rear major wall and aligned with each other in the longitudinal direction when said rear end portion is in the close position, and a screw fastener passing through said through holes.
